(19) United States
(12) Patent Application Publication
(10) Pub. No.: US 2010/0124072 A1
(43) Pub. Date: May 20, 2010

(54) AUTOMOBILE AND HEAD LIGHT SYSTEM THEREOF

(75) Inventor: Chia-Shou Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/468,866

(22) Filed: May 19, 2009

(30) Foreign Application Priority Data
Nov. 20, 2008 (CN) 200810305668.1

(51) Int. Cl. F21V 21/14

(52) U.S. Cl. 362/523

(57) ABSTRACT

A head light system of an automobile includes a normal head light and an auxiliary head light. The normal head light is fixedly mounted at a front end of the automobile. The auxiliary head light is provided at the front end of the automobile and includes a lamp body and a supporting member. The lamp body has a center of gravity. One end of the supporting member is fixedly mounted to the automobile. The lamp body is pivotally connected to another end of the supporting member. A pivotal connection point between the lamp body and the supporting member is located just above the center of gravity of the lamp body.

### BACKGROUND

1. Technical Field

The present invention relates generally to a head light system of an automobile, and more particularly to a head light system having a normal head light and an auxiliary head light for improving a security of the automobile.

2. Description of Related Art

Following the development of industrial technology, automobiles have become an inseparable part of our daily life. The automobile is an important tool by which people go to work, shopping, travel, etc., and renders many conveniences to people's modern life. However, traffic accidents always happen accompanying the use of automobiles. In recent years, the number of the traffic accidents has been growing.

The automobile moves on road, and a complicated road condition is generally a critical factor inducing the happening of traffic accidents. Referring to FIG. 4, an automobile 11 moves on a wavy road 10. The road 10 includes a valley 10a, a peak 10b, and an upwardly sloping road section 10c between the valley 10a and the peak 10b. The automobile 11 includes a head light 12 for illuminating ahead. The head light 12 is fixedly mounted at a front end of the automobile 11, and light beams 13 from the head light 12 illuminate ahead along a longitudinal axis of the automobile 11. When the automobile 11 moves from the sloping road section 10c and approaches the peak 10b of the road 10, the light beams 13 of the head light 12 illuminate towards the sky above the peak 10b, rather than towards the road surface 10d of the peak 10b. A lighting dead area exists on the road surface 10d of the peak 10b when the automobile 11 approaches the peak 10b. It is very dangerous for the driver of the automobile 11 at this particular moment since the driver cannot see clearly what happens in the lighting dead area.

Therefore, it is desirable to provide an automobile having an improved head light system.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 shows schematically an automobile moving on a wavy road according to an exemplary embodiment of the present invention.

FIG. 2(a) shows an auxiliary head light of the automobile of FIG. 1 located at a non-horizontal direction at a particularly instant moment.

FIG. 2(b) shows the auxiliary head light of FIG. 2(a) located at a horizontal direction after an automatic adjustment under the gravitational force.

FIG. 3 shows an auxiliary head light according to an alternative embodiment.

FIG. 4 shows schematically an automobile moving on a wavy road according to related art.

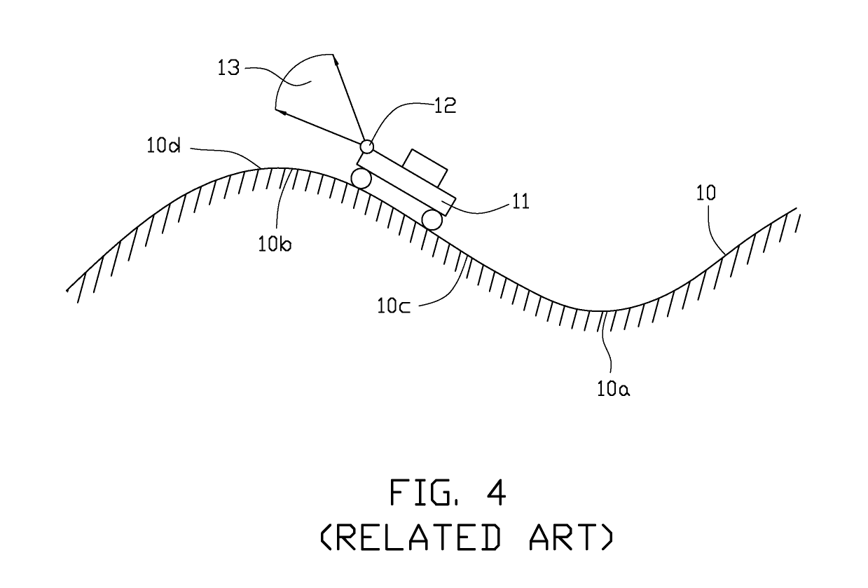

### DETAILED DESCRIPTION

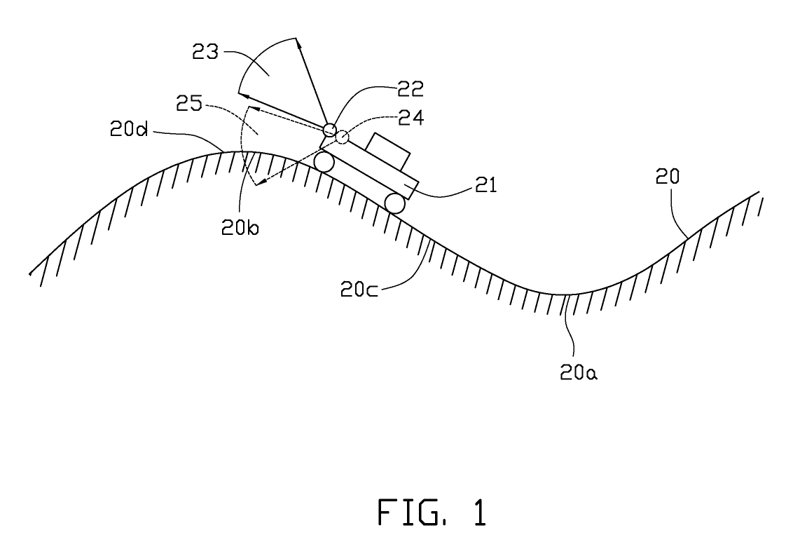

Referring to FIG. 1, an automobile 21 according to an exemplary embodiment of the present invention includes a normal head light 22 and an auxiliary head light 24. The normal head light 22 and the auxiliary head light 24 are mounted at a front end of the automobile 21. The normal head light 22 is the same as the conventional head light, and description of the normal head light 22 is therefore omitted hereinafter.

The auxiliary head light 24 is provided for reducing a lighting dead area of the ordinary head light 22 when the automobile 21 moves on a wavy road 10. The road 10 includes a valley 20a, a peak 20b, and an upwardly sloping road section 20c between the valley 20a and the peak 20b. The normal head light 22 is fixedly mounted in the automobile 21 for illuminating ahead, and light beams 23 from the normal head light 22 illuminate ahead along a longitudinal axis of the automobile 21. The auxiliary head light 24 is pivotally mounted in the automobile 21 and light beams 25 of the auxiliary head light 24 are always maintained in a horizontal direction. When the automobile 21 moves from the sloping road section 20c and approaches the peak 20b of the road 20, the light beams 23 of the normal head light 22 illuminate towards the sky above the peak 20b. However, the light beams 25 of the auxiliary head light 24 are maintained to illuminate towards the road surface 20d of the peak 20b, whereby a lighting dead area existed on the road surface 20d of the peak 20b in conventional arts is eliminated.

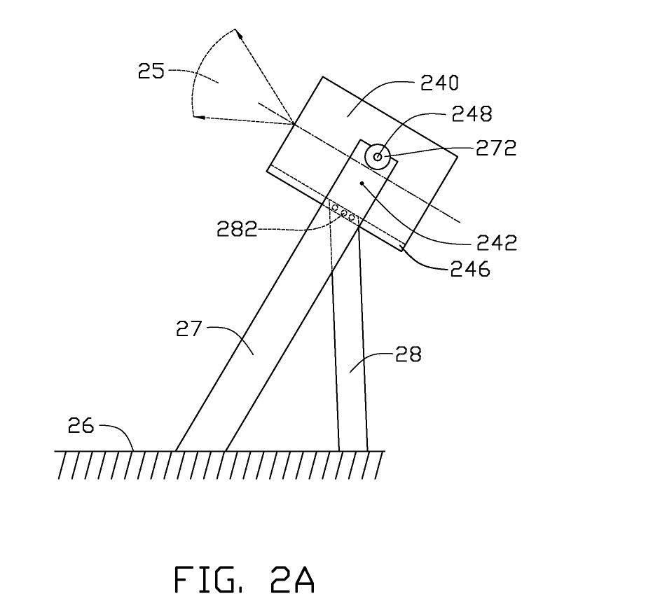

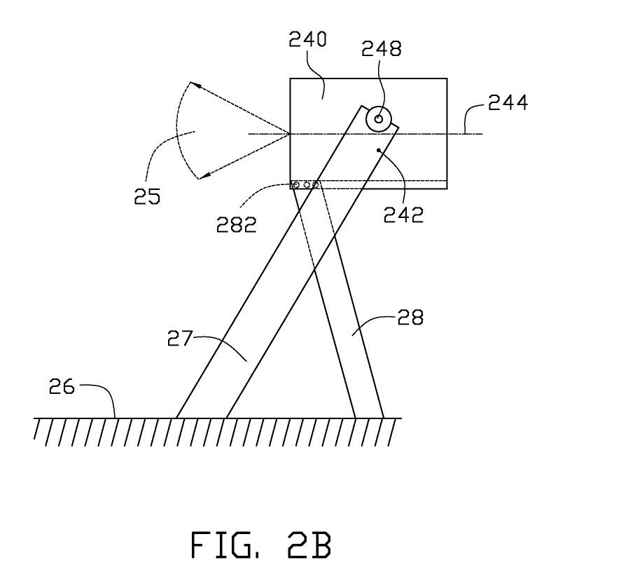

Referring to FIG. 2(a) and FIG. 2(b), the auxiliary head light 24 includes a lamp body 240 and a supporting member 27. In the embodiment, the supporting member 27 is a post. A bottom end of the supporting member 27 is fixedly mounted to a mounting base 26 of the automobile 21. The lamp body 240 of the auxiliary head light 24 is pivotally mounted to a top end of the supporting member 27. The lamp body 240 has a longitudinal axis 244 along a longitudinal direction thereof. The lamp body 240 has a center of gravity 242. The lamp body 240 is pivotally connected with the top end of the supporting member 27 via a pivot 272. The pivot 272 is located just above the center of gravity 242. The lamp body 240 and the supporting member 27 have a pivotal connection point 248 at the pivot 272. The center of gravity 242 is preferred to be located at or below the longitudinal axis 244 of the lamp body 240, and the pivotal connection point 248 between the lamp body 240 and the supporting member 27 is preferred to be located above or at the longitudinal axis 244 of the lamp body 240. In the illustrated embodiment, the center of gravity 242 is located below the longitudinal axis 244 of the lamp body 240, and the pivotal connection point 248 is located above the longitudinal axis 244 of the lamp body 240.

Since the pivotal connection point 248 between the lamp body 240 and the supporting member 27 is located just above the center of gravity 242 of the lamp body 240 and the lamp body 240 of the auxiliary head light 24 is pivotally connected with the supporting member 27, the auxiliary head light 24 has the ability of always maintaining the light beams 25 in a horizontal direction as shown in FIG. 2(b). If, at a particular instant moment, the auxiliary head light 24 is displaced to a non-horizontal direction as shown in FIG. 2(a), the auxiliary head light 24 will immediately pivot around the pivot 272 to the horizontal direction under the gravitational force.

A swing prevention mechanism is further provided to prevent the auxiliary head light 24 from swing when the auxiliary head light 24 moves from the non-horizontal direction to the horizontal direction. The swing prevention mechanism includes a crank 28. A bottom end of the crank 28 is pivotally connected with the mounting base 26. A top end of the crank 28 is connected with a plurality of rollers 282. A bottom side of the lamp body 240 of the auxiliary head light 24 is defined with a sliding slot 246. The rollers 282 are received in the sliding slot 246 and can slide freely in the sliding slot 246. A distance that the rollers 282 can slide in the sliding slot 246 limits a swing angle of the auxiliary head light 24. When the rollers 282 slide to one terminal end of the sliding slot 246, the auxiliary head light 24 will be stopped at that position, as shown in FIG. 2(b).

In the illustrated embodiment, the supporting member 27 is located below the auxiliary head light 24 and the auxiliary head light 24 is supported by the supporting member 27. Alternatively, the auxiliary head light 24 can also be hung in the automobile 21. For example, a top end of the supporting member 27 is connected with the automobile 21, and a bottom end of the supporting member 27 is pivotally connected with the lamp body 240 of the auxiliary head light 24.

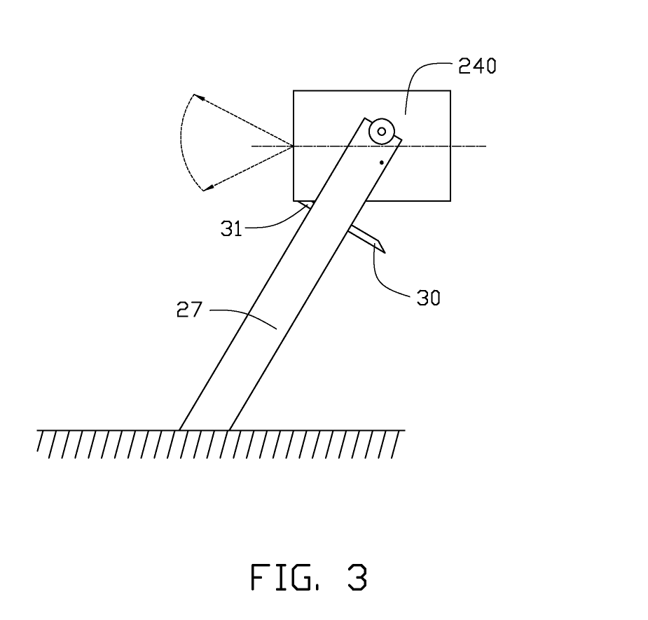

FIG. 3 shows an alternative embodiment of the auxiliary head light. The difference lies in the swing prevention mechanism. In this alternative embodiment, the swing prevention mechanism includes a rod 30 fixedly mounted on the supporting member 27 at a position near the top end of the supporting member 27. The rod 30 has a top free end 31 facing the auxiliary head light 24. When the auxiliary head light 24 rotates from the non-horizontal direction to the horizontal direction under the gravitational force, a bottom of the auxiliary head light 24 contacts with the top free end 31 of the rod 30, whereby the auxiliary head light 24 is stably stopped at the horizontal direction.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A head light system of an automobile comprising:
a normal head light fixedly mounted at a front end of the automobile; and
an auxiliary head light being provided at the front end of the automobile, the auxiliary head light comprising a lamp body and a supporting member, the lamp body having a center of gravity, one end of the supporting member being fixedly mounted to the automobile, the lamp body being pivotally connected to another end of the supporting member, a pivotal connection point between the lamp body and the supporting member being located just above the center of gravity of the lamp body.

2. The head light system as claimed in claim 1, wherein the lamp body has a longitudinal axis along a longitudinal direction thereof, the center of gravity of the lamp body is located below the longitudinal axis of the lamp body, and the pivotal connection point between the lamp body and the supporting member is located above the longitudinal axis of the lamp body.

3. The head light system as claimed in claim 1, wherein the auxiliary head light further comprises a crank, a bottom end of the crank is pivotally connected with the automobile, a top end of the crank is connected with a plurality of rollers, a bottom side of the lamp body is defined with a sliding slot, the rollers are freely received in the sliding slot so that the rollers are movable in the sliding slot.

4. The head light system as claimed in claim 1, wherein the auxiliary head light further comprises a rod fixedly mounted on the supporting member at a position near a top end of the supporting member, the rod has a top free end facing the auxiliary head light, a bottom of the auxiliary head light contacts with the top free end of the rod when the auxiliary head light rotates from a non-horizontal direction to a horizontal direction under a gravitational force acting on the lamp body of the auxiliary head light.

5. The head light system as claimed in claim 1, wherein the lamp body is pivotally connected with a top end of the supporting member via a pivot.

6. An automobile comprising:
a normal head light fixedly mounted at a front end of the automobile; and
an auxiliary head light being provided at the front end of the automobile, the auxiliary head light comprising a lamp body and a supporting member, the lamp body having a center of gravity, one end of the supporting member being fixedly mounted to the automobile, the lamp body being pivotally connected to another end of the supporting member, a pivotal connection point between the lamp body and the supporting member being located just above the center of gravity of the lamp body.

7. The automobile as claimed in claim 6, wherein the lamp body has a longitudinal axis along a longitudinal direction thereof, the center of gravity of the lamp body is located below the longitudinal axis of the lamp body, and the pivotal connection point between the lamp body and the supporting member is located above the longitudinal axis of the lamp body.

8. The automobile as claimed in claim 6, wherein the auxiliary head light further comprises a crank, a bottom end of the crank is pivotally connected with the mounting base, a top end of the crank is connected with a plurality of rollers, a bottom side of the lamp body is defined with a sliding slot, the rollers are freely received in the sliding slot so that the rollers are movable in the sliding slot.

9. The automobile as claimed in claim 6, wherein the auxiliary head light further comprises a rod fixedly mounted on the supporting member at a position near a top end of the supporting member, the rod has a top free end facing the auxiliary head light, a bottom of the auxiliary head light contacts with the top free end of the rod when the auxiliary head light rotates from a non-horizontal direction to a horizontal direction under a gravitational force acting on the lamp body of the auxiliary head light.
